(19) United States
(12) Patent Application Publication
(10) Pub. No.: US 2005/0210858 A1
(43) Pub. Date: Sep. 29, 2005

(54) Scoop generator

(76) Inventors: Gerald E. Gore, Kutztown, PA (US); Francine J. Gore, Kutztown, PA (US)

Correspondence Address: EZRA SUTTON, P.A.;PLAZA 9 BUILDING, SUITE 201, 900 ROUTE 9 NORTH, WOODBRIDGE, NJ, 07095, US

(21) Appl. No.: 10/811,250

(22) Filed: Mar. 26, 2004

(51) Int. Cl. B60K 1/00

(52) U.S. Cl. 60/201

(57) ABSTRACT

Apparatus for producing light from a self-generating source of energy, including: a) a light to provide illumination; b) a self-generating source of energy, such as a wind turbine; and c) means to transfer energy to the light.

### FIELD OF THE INVENTION

This invention relates to motorcycles, internal combustion cars and trucks, hybrid internal combustion vehicles, hybrid fuel cell internal combustion vehicles and methods and devices to provide electric power.

### BACKGROUND OF THE INVENTION

This invention relates to motorcycles, internal combustion cars, trucks, hybrid internal combustion vehicles, hybrid fuel cell internal combustion vehicles and their need for power.

The prior art has provided much discussion about ways and means to effectively bring additional power to vehicle types that need the power, especially battery powered vehicles and internal combustion vehicles. These vehicles due to the dating of the prior art gave the connotation of electric to the battery vehicles. The batteries in these vehicles were the only power source for these vehicles. By contrast, fuel cell vehicles are now being called electric vehicles but were not addressed in the past art.

Technologies have evolved, mass produced battery powered vehicles were not successful and are out. Hybrid internal combustion vehicles are here today and fuel cell vehicles are on the horizon. Fuel cells vehicles are not battery vehicles, if commercialized they do not need the battery banks of battery vehicles. They will not need recharging like battery vehicles and they will not combust fuels such as internal combustion vehicles. Typically, internal combustion vehicles are deemed able to produce more mechanical and electrical power than they require. However, to add power to these vehicles, wind generators were proposed for internal combustion vehicles. The wind generators may have operated if placed on these vehicles but they were not successful. Internal combustion vehicles are not running up and down the highway with wind turbines, or flywheels, they combust hydrocarbon fuels and they pollute if o,y performed as expected on these vehicles but they were not successful. They were not a success because of a lack of need for energy but more so for the cost and weight of energy storage. The same wind generators were proposed for the salvation of the electric vehicles, especially battery vehicles but as is obvious on the highways they were not successful in that application either.

The common statement is that there is no free lunch. This especially applies to energy. Wind turbines did not save the electric vehicle and allow it to be mass produced and rule the highways. Fly wheels were not the answer. Wind generators, fly wheels and batteries together did not save the electric vehicle nor are they in use in vehicles today. Special materials have not saved the electric vehicle. Even the superb engineering by General Motors for the EVl could not make it a commercial success. Aerodynamics did not offer the solution for these vehicles. As a mass produced highway vehicle the battery vehicle is dead.

Despite the desire to replace it, the internal combustion vehicles rule the road. Prior patents, products, and technologies have attempted to help replace this power plant but they have not met the test of commercial viability. Energy sources for vehicles to help replace the internal combustion engine such as fuel cells have proven to be and remain an extremely complex challenge.

This invention is not a replacement for the internal combustion engine. No single patent will solve all the energy needs for all vehicles but the present invention is an improvement for providing energy to vehicles. The present invention offers unique methods of energy generation and especially energy use in vehicles.

People own and operate vehicles, these owners want more services from more equipment being added to their vehicles. The demand for electricity is growing in the vehicular market place as it is growing on the home and business front. Vehicles of all types need energy and they all want more. Even the internal combustion vehicles are using more and more energy, their housekeeping loads have dramatically increased over time.

The focus of this invention is power for vehicles. Its innovations are in generation and dual use devices and in energy use applications. This invention offers unique, innovative and commercially viable improvements as to how, why and where energy is used in a vehicle. This invention is an improvement and is one of the pieces, one of the missing parts of the puzzle.

This invention will have a small increase on drag and weight. Nevertheless, no engine, battery or other power source comes without a price. Moreover, unfortunately aerodynamics is and has not been the answer for providing power to power starved vehicles. This invention provides one answer and is improvement to electric power and vehicles.

Hood scoops are used in internal combustion automobiles to provide air to the engine, specifically the carbureting system.

This invention recognizes the need for additional electricity to be made available to vehicles. Battery powered vehicles, fuel cell vehicles and even internal combustion hybrid vehicles do not have a hood scoop. By their nature, they do not have carburetors and do not need scoops to provide forced air to enhance carbureting.

In order to improve the commercial viability of vehicles, energy improvements should not have the pitfalls attributed commonly to batteries or pure internal combustion vehicles. The methods, apparatus and devices should not be heavy, not be reduced in efficiency by cold weather, be none polluting, environmentally friendly and help extend the life of batteries for internal combustion hybrid vehicles, and help to speed the introduction of non polluting fuel cell vehicles. These are some of the attributes of this invention.

### SUMMARY OF THE DRAWINGS

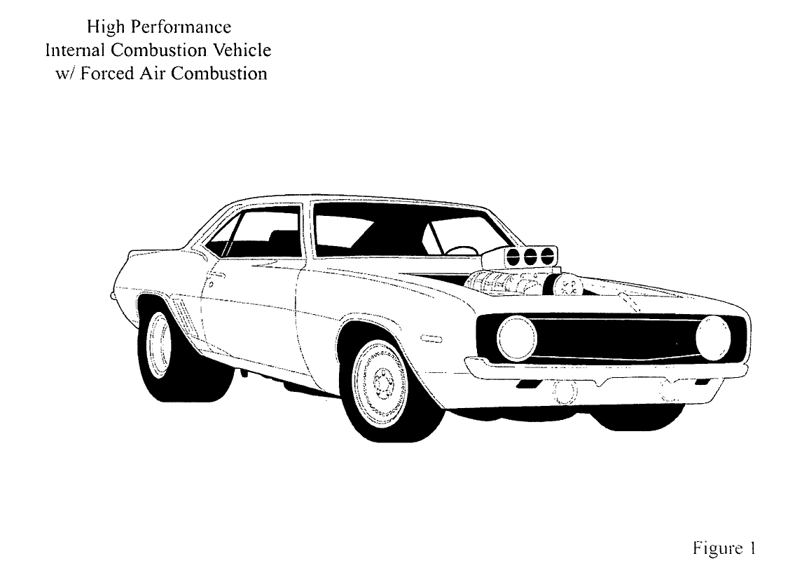

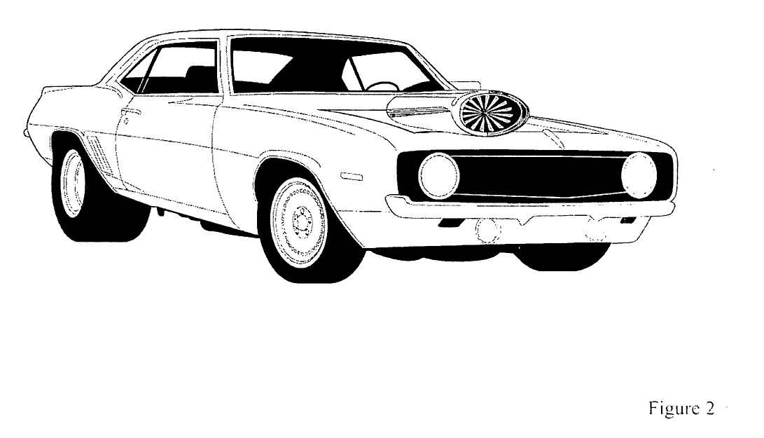

A. FIG. 1 shows an internal combustion vehicle with a hood opening with the engine above the level of the hood and with a device to direct air into the carbureting system of the internal combustion vehicle.

B. FIG. 2 shows a vehicle at a slight angle with a scoop generator system that is front and near center of the vehicle hood. This figure presents the turbine in a clear view.

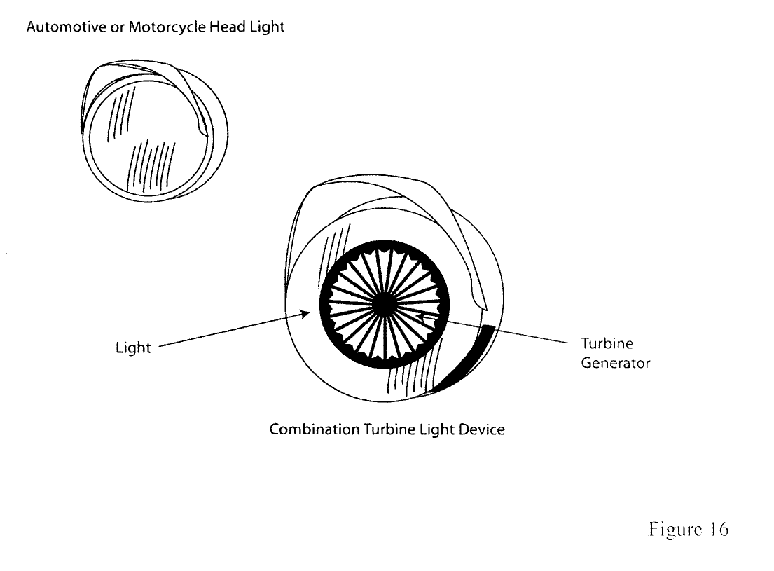

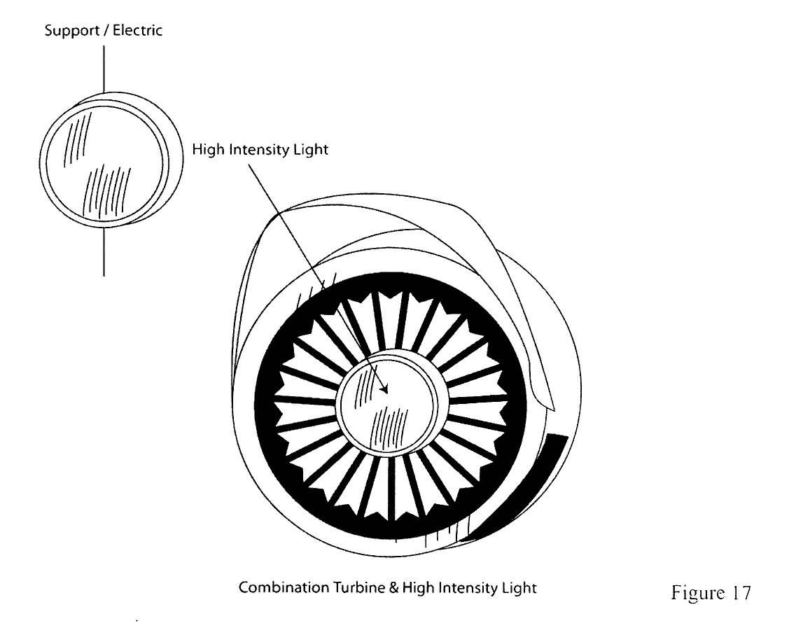

The illustration shows a scoop with a turbine. The turbine as shown is one turbine embodiment. This turbine and others depicted in FIGS. 16 and 17 show other turbine embodiments that are a part of the present invention. Turbines as illustrated can also be the scoop, light and power systems of these figures.

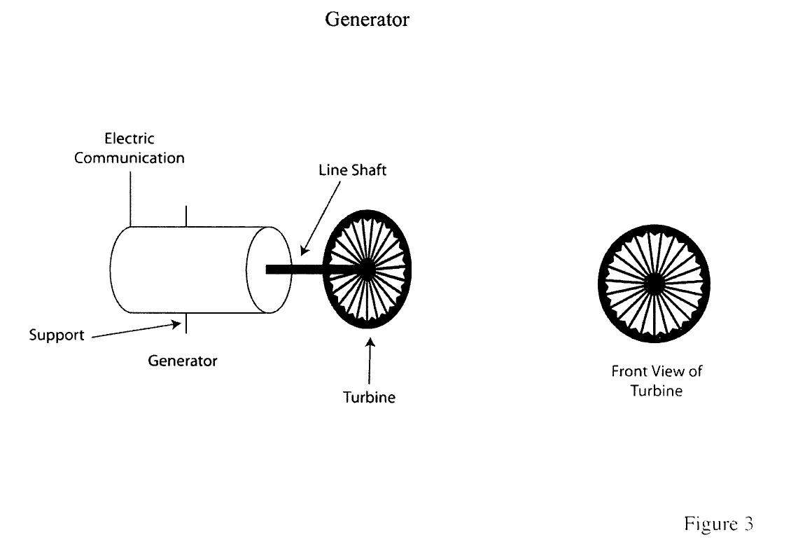

C. FIG. 3 shows a head on front view of the turbine and a view of the turbine generator for placement into the scoop.

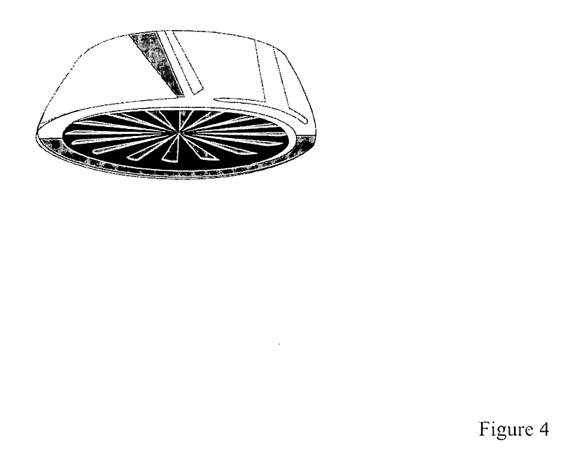

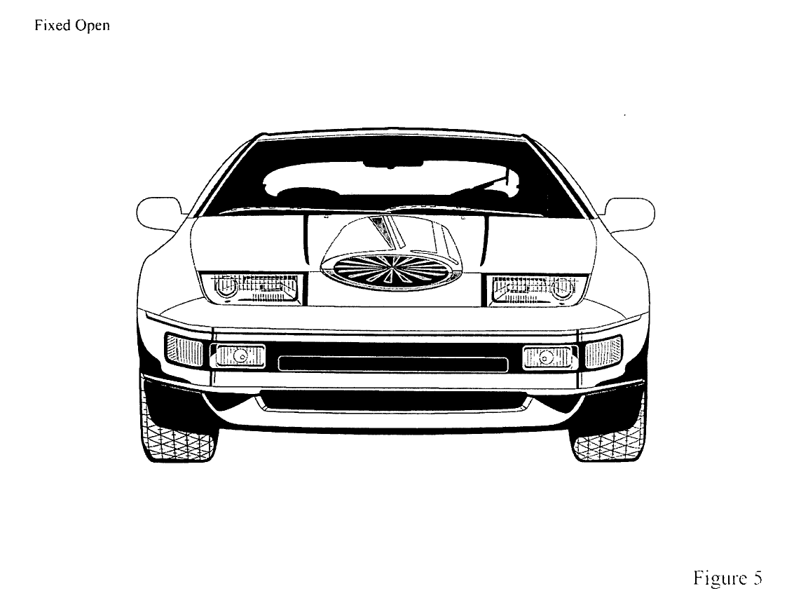

D. FIG. 4 shows a head on view of a scoop generator system. The scoop generator can be open in the rear to direct the airflow out, or direct the airflow to wherever in the vehicle airflow might be desired.

E. FIG. 5 shows a head on view of a vehicle with a scoop generator affixed to the hood. The scoop generator is presented with a fixed open turbine opening.

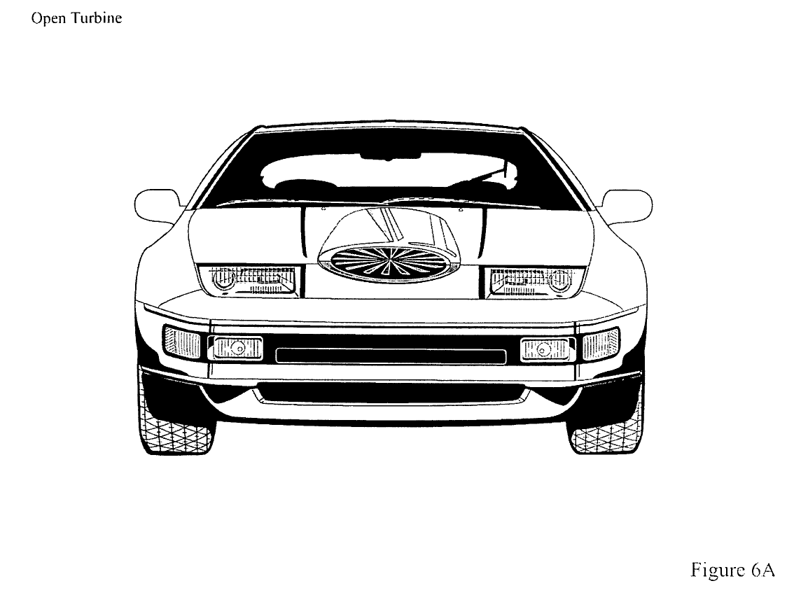

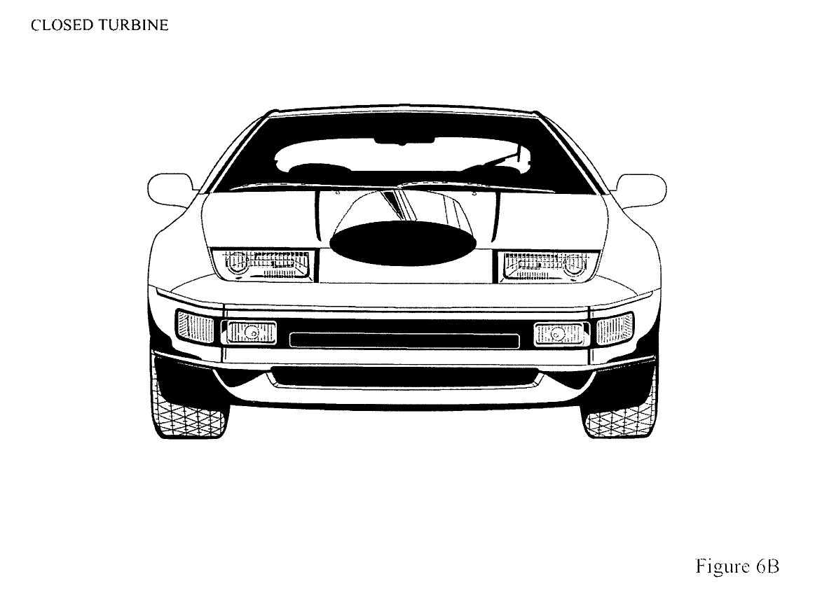

F. FIG. 6a shows a head on view of a vehicle with a scoop generator affixed to the hood. The scoop generator is presented with an operable scoop opening that can open or close and the scoop presented with the scoop open without lighting.

G. FIG. 6b shows a head on view of a vehicle with a scoop generator affixed to the hood. The scoop generator is presented with an operable scoop opening that can open or close and the scoop presented with the scoop closed.

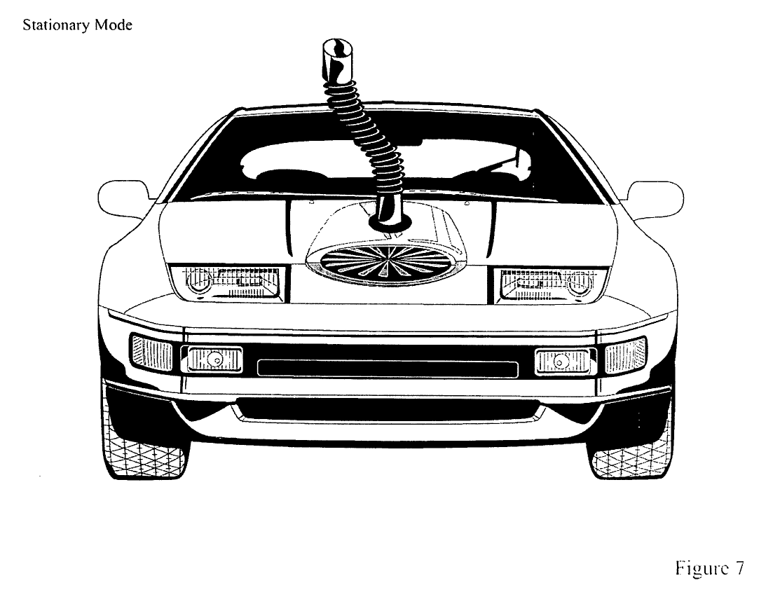

H. FIG. 7 shows a head on view of a vehicle with a scoop generator affixed to the hood. This system is presented with a topside opening on the scoop. The topside of the system has a topside opening with a flexible pipe for exhaust purposes. The exhaust is for a stationary mode.

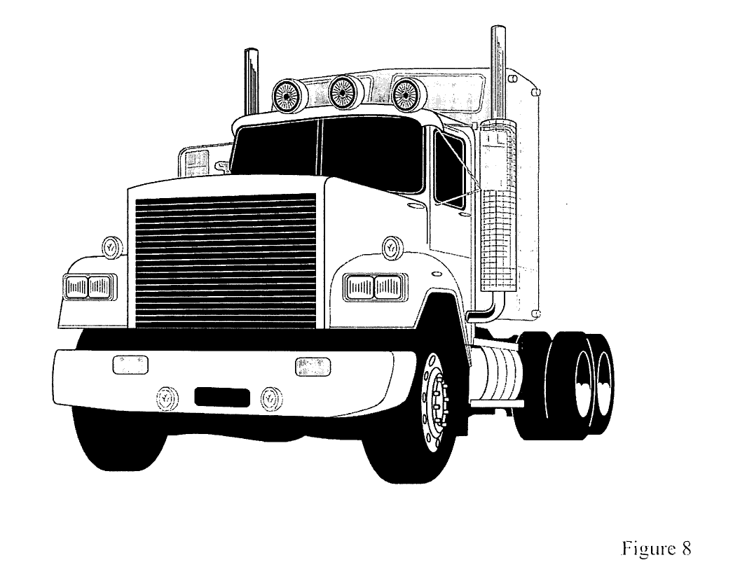

I. FIG. 8 shows the cab or tractor of a long haul tractor-trailer. The tractor is presented with a front view that is slightly angled for better illustration and the cab is noted as having a live in rear cab with two forward-looking windows. The scoop system is flexible in sizing needs and this illustrates three (3) scoop generators atop the cab. These do not totally obscure the windows. The system can be sized as needed and are illustrated to have the approximate size of lights and therefore have a truck like component appearance to gain acceptance. Size and number are to meet an electric load level.

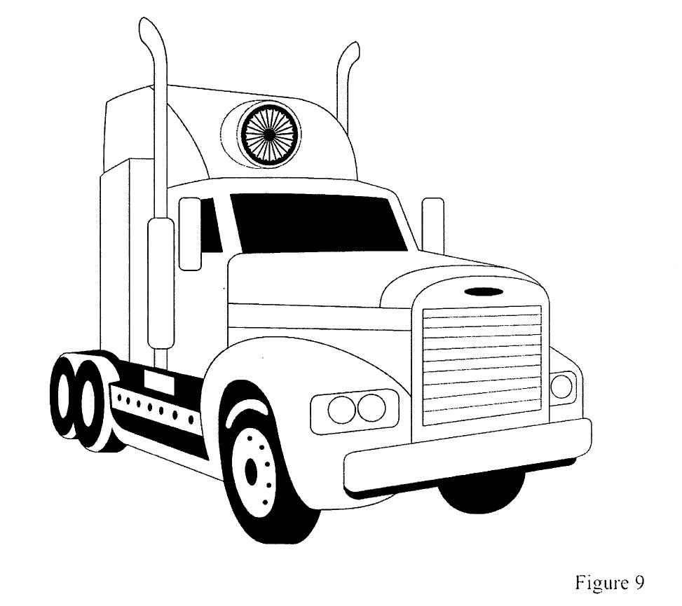

J. FIG. 9 shows the cab or tractor of a long haul tractor-trailer. The tractor is presented with a front view that is slightly angled for better illustration. The cab is presented with a large air deflector sitting above the driver's compartment and extends above a live in or other use rear compartment. The scoop system is incorporated into the air deflector. The size of the scoop system is correctly illustrated as larger than any system previously illustrated and can therefore generate more electricity.

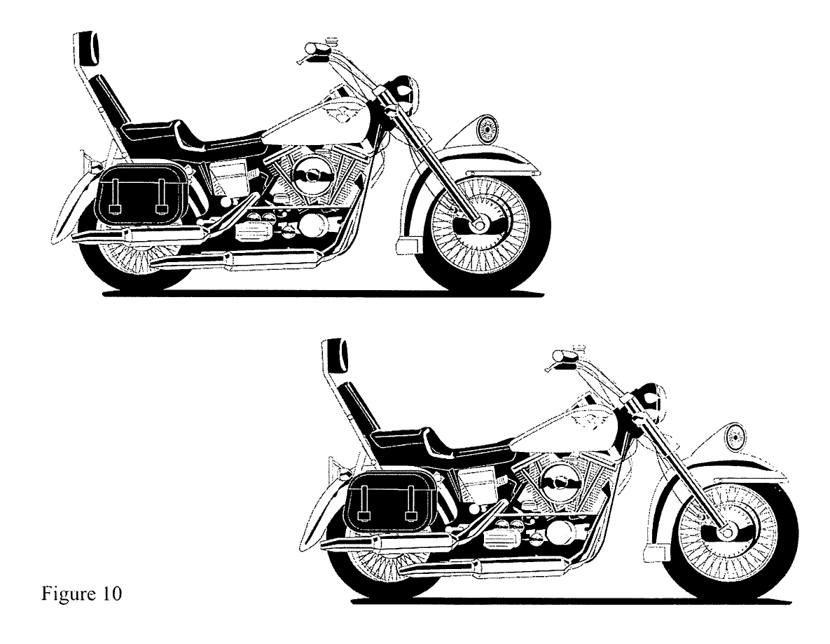

K. FIG. 10 shows two motorcycles with a side view. Each of the motorcycles has a scoop generator system on top of the front fender or wheel cover. The top motorcycle has the scoop generator sized for the wheel cover and the scoop has been mounted on the cover. The bottom motorcycle illustrates the scoop has been sized for the wheel cover and illustrates its incorporation as an integral part of the front wheel cover. Motorcycles have two exhaust pipes. Both of the motorcycles shown have their exhaust pipes on the same side. However, many motorcycles have a single pipe on each side. The system in this representation is not illuminated.

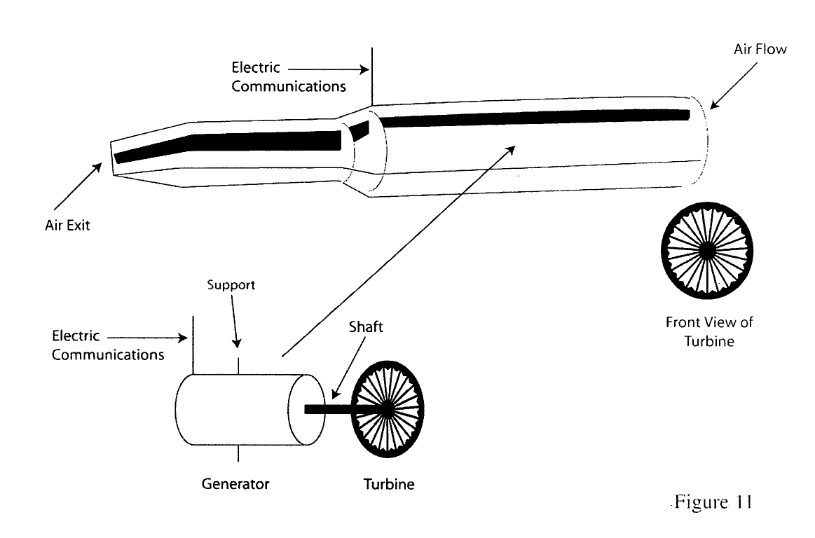

L. FIG. 11 shows motorcycle muffler like housing, without the baffle insert or any internal components. The housing is open at both ends to allow air to enter and air to leave. The wind generator is installed within the housing and produces electricity. The muffler system uniquely generates electricity without injuring the overall look or design of the motorcycle.

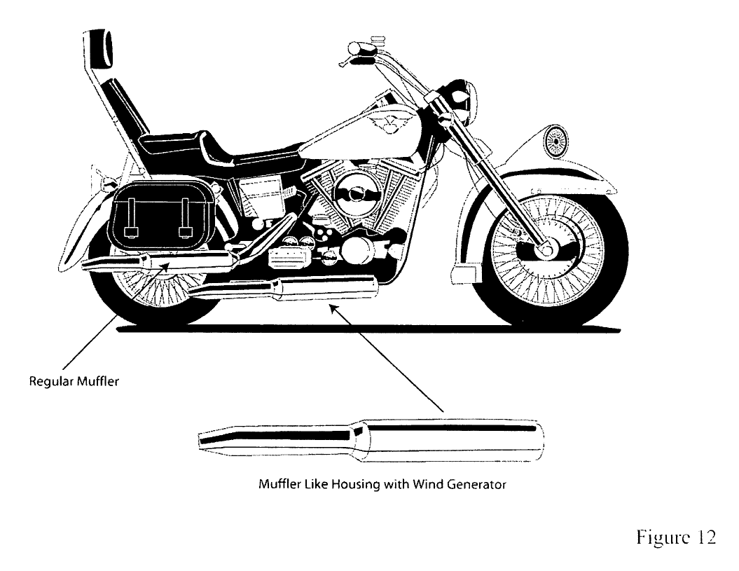

M. FIG. 12 shows a motorcycle with a side view. The motorcycle has two exhaust pipes, they are located one on each side of the vehicle. This motorcycle is also equipped with an embodiment, an apparatus of the present invention. The device and muffler are indicated on the illustration. A similar configuration is lactated on the opposite side of the motorcycle also. This motorcycle also has an embodiment of the present invention on each side of the motorcycle as well. The device is substantially the device as illustrated in FIG. 11.

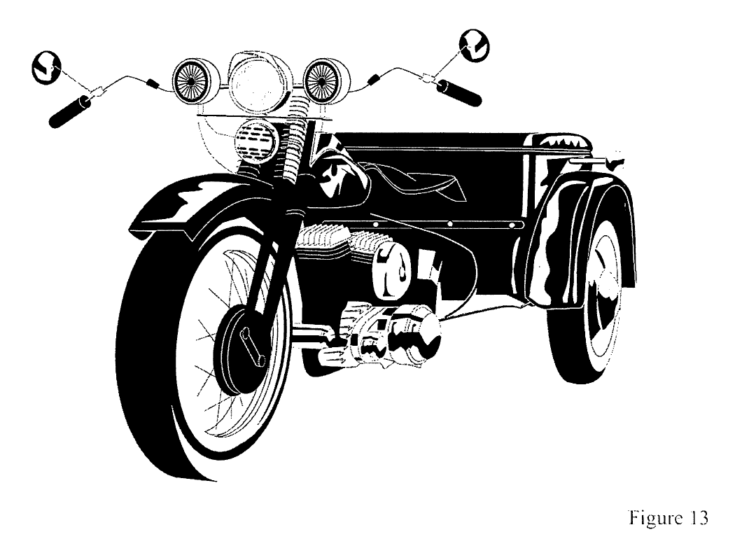

N. FIG. 13 shows a three wheel motorcycle with the present invention shown in two units attached to the handlebar of the vehicle.

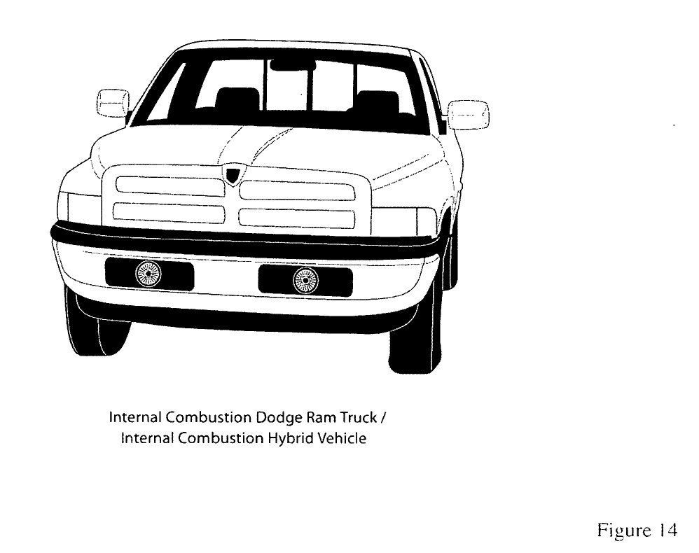

O. FIG. 14 shows an Internal Combustion Dodge Ram Truck and an Internal Combustion Hybrid Dodge Ram Truck. The front openings of the truck are used to cool the internal combustion engine of both vehicle representations and are also used to cool brakes. The present invention is incorporated within these openings. The invention incorporates the wind generator in the flow of air from the opening to generate electricity with the flow of air continuing to cool the brakes.

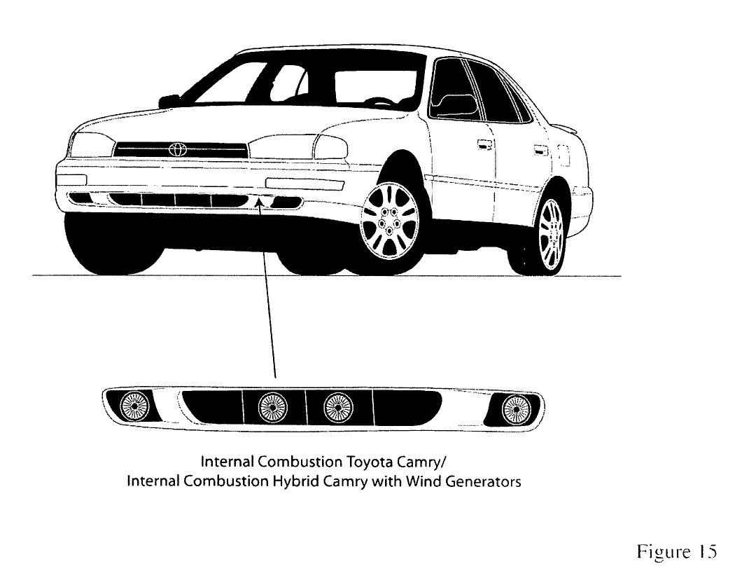

P. FIG. 15 shows the cowling of the Internal Combustion Toyota Camry and the Internal Combustion Hybrid Toyota Camry. The magnified illustration of the cowling illustrates the openings have been incorporated with an embodiment of the present invention.

Q. FIG. 16 shows a combination light and turbine device. The light is for identification and illumination and uniquely is self powering as the vehicle moves forward.

R. FIG. 17 shows a combination high intensity light and turbine device. The light is for identification and illumination and uniquely is self powering as the vehicle moves forward.

### SUMMARY OF THE INVENTION

This invention relates to motorcycles, internal combustion cars and fuel trucks, cell vehicles, hybrid internal combustion vehicles, hybrid fuel cell internal combustion vehicles and methods and devices to provide electric power.

Electric power for and from vehicles is a focus of the present invention. The present invention is an improvement of the providing of electricity to vehicles and is also a unique improvement in the utilization of electricity on board vehicles.

This invention is not a battery, East Penn Manufacturing and Exide and others are diligently working to improve batteries. This invention is not a fuel cell, Ballard Power, Plug Power and others are working on these. A young fuel cell manufacturer of fuel cells and fuel cell test equipment is making great strides in the area of PEM fuel cells and needed improvements to fuel cell balance of plant that company is Hydrogenics, of Canada.

This invention is neither battery nor a fuel cell. This invention is not a new internal combustion engine.

The internal combustion engine is attached to the vehicle to produce power. By its current up and down motion, stresses are produced as it produces and transfers its power it is also producing pollutants during this production of power. Many would like to replace the internal combustion engine, it pollutes, it is heavy, it is costly, but still manageable in cost to be the most widely distributed power source for vehicles.

Fuel cells and predicted by many as its replacement. Fuel cells are expensive, balance of plant is expensive. It also uses a fuel and it needs a means to transfer its power. Fuel and fuel infrastructure are two very significant challenges.

This invention is supportive of the internal combustion hybrid, fuel cell hybrid vehicle and especially the fuel cell vehicle. This invention will hasten the introduction of a fuel cell or hybrid fuel cell vehicle.

This invention utilizes air, moving air as a power source for the electric vehicle. The present invention is not the sole power source for the electric vehicle. It will add some cost, but it will be minimal compared to other automotive power plant systems, it is commercially feasible and viable.

In one embodiment of the present invention, the invention improves an electric vehicle and incorporates a hood scoop on an electric vehicle. Automotive hood scoops are made for air flow to enhance carbureting. Hood scoops are for enhanced carburations are not essential or desirable for the pure gasoline powered vehicles. This invention when partnered with the battery powered and electric vehicle will provide a new source of electricity for these vehicles. This invention uniquely recognizes the hood scoop and improves it and brings it innovatively to the world of the battery powered and electric vehicle. The scoop is used innovatively and will uniquely use the flow of air to produce electricity to charge batteries.

The hood scoop is attached to the hood covering the forward compartment of the battery powered vehicle. This scoop will provide air powered by the force of the wind or forward motion of the vehicle or a combination thereof to be channeled to a turbine. The air impacts the turbine; the turbine turns also turning a shaft to produce electricity from a generator. This turbine, or fan blade or other means is turned to produce electricity. Uniquely this invention utilizes a hood scoop with generator to produce electricity from air movement of the battery powered automobile and can also use this same air flow as a hydrogen purge at the same time. The present invention by extension could also provide electricity for electric vehicles, hybrid vehicle and fuel cell vehicles. The system could provide electricity for range extension and its cost per kilowatt of electric production would certainly be less than fuel cell systems. By its nature, this invention can help to reduce the overall cost of a fuel cell vehicle and help to speed their introduction commercially.

This invention recognizes that sensors could be included in the scoop system to detect the true direction and force of natural wind. As an example, the scoop system can have a closing mechanism that could be opened in the event the vehicle is on and not moving and a wind of sufficient magnitude is detected to turn the turbine mechanism. A battery powered vehicle could be sitting in traffic, not moving but its scoop generator could be turning, and it could be taking advantage of a gift of mother nature, the wind. The resulting electricity could be used for charging its batteries or providing electricity for housekeeping purposes. A parked battery powered vehicle could be off and use the electricity from the turbine to vent heated air within the vehicle. This invention also recognizes and incorporates that sensors detecting the need for electricity can open the scoop, if closed; whether the vehicle is off or on to obtain wind to keep the vehicle in a minimum state of charge. This could also benefit many vehicles and types such as automobiles in long term parking at airports such as Newark International Airport in New Jersey and at remote parking lots such as one might find at a major university such as Penn State University.

Vehicles of many types can benefit from this invention because vehicles of all types are making more and more use of electricity. Long haul trucks may not need this invention but that does not mean that even they can not benefit from its adoption. Long haul trucks can use additional electricity and can easily carry larger turbines to provide larger amounts of electricity for their housekeeping loads. Many of these truck cabs carry the essence of a home with them. These vehicles often carry microwaves, televisions, refrigerators and additional heating and cooling devices in the rear section. With team driving there is relatively little or no down time for the electric systems. The housekeeping load is increasing dramatically. Demands on the trucks electric system to power refrigerated trailers could also be reduced and thereby reducing fuel requirements and extending the life of the generating system. Such turbines could produce electricity to charge batteries, power an electrolyzer to produce hydrogen or power the myriad of lights aboard a truck and trailer. Cabs that pull two trailers could significantly benefit from this invention.

This invention recognizes and incorporates that fuel cell trucks can make their own hydrogen fuel and can also be introduced quicker if they need fewer numbers of fuel cells.

Battery powered motorcycles can incorporate this invention onto the front fender or front wheel cover of a motorcycle or motor scooter. The scoop can also be fabricated and be a part of the front fender of the motorcycle. Motorcycles are using more electricity, in fact Harley Davidson Motorcycles and side cars have multiple systems requiring electricity. A scoop turbine system could also be incorporated on the front of a side car.

Although not a preferred embodiment this invention, it recognizes and incorporates that a vehicle hood can incorporate a scoop topside opening and closure mechanism to aid in the dissipation of heat from an engine. The scoop topside opening and closure mechanism can also be utilized as a vent and as a vent it can have locations other than the hood. For those practicing this invention and especially this embodiment of the invention, care must be taken to prevent young children from having access to any device having a closure system.

A screen or other means may be added to the front of an open system. A screen or other means may be added behind the closure mechanism of any system with a closure mechanism. The screens can deflect debris, prevent nesting and animal and possibly also deter any mischief.

Although not a preferred embodiment the scoop system can be mounted on the roof of a vehicle. Additionally, the scoop system can be affixed to the vehicle inside the engine or front compartment and can be with or without the scoop. The scoop generator system can utilize the exhaust pipe of the vehicle as a scoop to utilize the vehicle exhaust as wind. Vehicles can have one or more scoop generator systems.

The use of vehicle does not limit the claims to car, truck or motorcycle. This invention is applicable to ships and boats. It is also appropriate for both power and sailing craft. Although the preferred embodiment is with the scoop system permanently affixed to a vehicle this invention recognizes and incorporates that the scoop system can be affixed to mounting to be able to thereby direct the scoop generator into the wind with less limitations on wind direction.

This invention further recognizes and incorporates that parking at truck stops, remote parking and long term parking lots should direct and should provide parking spaces more directed toward the prevailing winds.

### PREFERRED EMBODIMENT OF THE INVENTION

In the text, which follows below, the preferred embodiment of the invention is discussed and represented in a number of illustrative diagrams.

A. FIG. 1 shows an internal combustion engine vehicle, the vehicle is facing forward with a slight cant toward the right.

The air ports of the carbonation system and a portion of the engine are above the line of the hood.

This is a high performance vehicle, a scoop or hood covers this engine. However, this figure illustrates that a cover would direct the air into the carbureting ports atop the engine and illustrates what is beneath the cover, namely a gasoline carbureting system to produce mechanical energy to move the vehicle. The present invention incorporates the hood or turbine cover to be part of the dual use system to produce electric power and or light.

The vehicle of FIG. 1 even with a scoop does not need more power and certainly does not need power that is more electric. The present invention is also unique assemblages of unique vehicles with unique power plants and the addition of an additional power plant.

B. FIG. 2 shows the scoop system positioned on the hood of a vehicle, the vehicle is a fuel cell, fuel cell hybrid vehicle, internal combustion or internal combustion hybrid vehicle and the air directed by the scoop to a turbine turns a generator and the resulting electricity is directed to the vehicle's electric bus system where the electricity or battery/batteries systems or control system. The same applies when the vehicle is a hybrid fuel cell, or hybrid fuel cell vehicle.

C. FIG. 3 shows a head on front view of the turbine and a view of the turbine generator for placement into the scoop.

D. FIG. 4 shows a head on view of a scoop generator system. The scoop generator is open in the rear to direct the air flow out, or is ducted to direct the air flow to wherever in the vehicle air flow might be desired.

E. FIG. 5 shows a head on view of a vehicle with a scoop generator affixed to the hood. The scoop generator is presented with a fixed open turbine opening.

F. FIG. 6a shows a head on view of a vehicle with a scoop generator affixed to the hood. The scoop generator is presented with an operable scoop opening that can open or close and the scoop presented with the scoop open.

G. FIG. 6b shows a head on view of a vehicle with a scoop generator affixed to the hood. The scoop generator is presented with an operable scoop opening that can open or close and the scoop presented with the scoop closed.

The preferred direction of the turbine is full face outward and the full face of the scoop opening accessible to the air, and so the shaft is parallel or near parallel with the hood.

H. FIG. 7 shows a head on view of a vehicle with a scoop generator affixed to the hood. This system is presented with a topside opening on the scoop. The topside of the system has a topside opening with a flexible pipe that can be inserted into the top scoop opening for exhaust purposes. The exhaust is for a stationary mode.

With the inclusion of an electric motor or other means into the scoop system, the scoop could be uniquely used to cool or vent a system or a vehicle.

Although not a preferred embodiment of the present invention, an additional embodiment is the operable scoop on a gasoline or internal combustion vehicle for eliminating heat build up from stop and go or stopped traffic. The two opening scoop or the operable opening is incorporated in the vehicle hood. The device is operable manually or by sensor, actuating an opening and closing device or devices based on a) the heat within the engine compartment or b) the operating speed of the vehicle or c) the sensed air flow to a sensor.

Uniquely this invention allows this vehicle to operate in a stationary mode to produce electricity to off board for the vehicle to a load. This embodiment of the present invention is also applicable to internal combustion vehicles and hybrid vehicles. This motor is able to be in the scoop, in the compartment to be vented, in the flexible pipe or apart of a vent to the exterior of a building. The motor would turn the blades drawing cooling air into and through the scoop to be forced down into the engine to dissipate heat out of the engine compartment. This invention can also be utilized to pull hot air off of the engine and directing the flow of hot engine air upward and a hose or other means could direct the hot air and any exhaust out of an enclosed area such as a garage.

This invention is innovative as it is used in conjunction with a parked vehicle such as a fuel cell vehicle, hybrid fuel cell vehicle, hybrid electric, and even an internal combustion vehicle that is running for producing electricity. This use incorporates a means for transferring the electricity from the vehicle to a power a load. Power Park® Technologies is the preferred means to accomplish the transfer of electricity to a load. This same invention embodiment uniquely operates for multiple functions. The scoop generator system generates electricity from moving air while the vehicle is moving. And also has the dual use to cool an engine where the vehicle is stationary but operating to produce electricity for on board or off board utilization. This cooling feature is especially necessary for internal combustion vehicles, hybrid electric vehicles with internal combustion engines that would be utilized for the purpose of electric generation.

I. FIG. 8 shows the cab or tractor of a long haul tractor-trailer. The tractor is presented with a front view that is slightly angled for better illustration and the cab is noted as having a live in rear cab with two forward-looking windows. The scoop system is flexible in sizing needs and this illustrates three (3) scoop generators atop the cab. These do not totally obscure the windows. The system can be sized as needed and are illustrated to have the approximate size of lights and therefore have a truck like component appearance to gain acceptance. Size and number are to meet an electric load level.

J. FIG. 9 shows the cab or tractor of a long haul tractor-trailer. The tractor is presented with a front view that is slightly angled for better illustration. The cab is presented with a large air deflector sitting above the driver's compartment and extends above a live in or other use rear compartment. The scoop system is incorporated into the air deflector. The size of the scoop system is correctly illustrated as larger than any system previously illustrated and can therefore generate more electricity.

K. FIG. 10 shows two motorcycles with a side view. Each of the motorcycles has a scoop generator system on top of the front fender or wheel cover. The top motorcycle has the scoop generator sized for the wheel cover and the scoop has been mounted on the cover. The bottom motorcycle illustrates the scoop has been sized for the wheel cover and illustrates its incorporation as an integral part of the front wheel cover. Motorcycles have two exhaust pipes. Both of the motorcycles shown have their exhaust pipes on the same side. However, many motorcycles have a single pipe on each side. The system in this representation is not illuminated.

L. FIG. 11 shows motorcycle muffler like housing, without the baffle insert or any internal components. The housing is open at both ends to allow air to enter and air to leave. The wind generator is installed within the housing and produces electricity. The muffler system uniquely generates electricity without injuring the overall look or design of the motorcycle.

M. FIG. 12 shows a motorcycle with a side view. The motorcycle has two exhaust pipes, they are located one on each side of the vehicle. This motorcycle is also equipped with an embodiment, an apparatus of the present invention. The device and muffler are indicated on the illustration. A similar configuration is lactated on the opposite side of the motorcycle also. This motorcycle also has an embodiment of the present invention on each side of the motorcycle as well. The device is substantially the device as illustrated in FIG. 11.

N. FIG. 13 shows a three-wheel motorcycle with the present invention shown in two units attached to the handlebar of the vehicle.

O. FIG. 14 shows an Internal Combustion Dodge Ram Truck and an Internal Combustion Hybrid Dodge Ram Truck. The front openings of the truck are used to cool the internal combustion engine of both vehicle representations and are also used to cool brakes. The present invention is incorporated within these openings. The invention incorporates the wind generator in the flow of air from the opening to generate electricity with the flow of air continuing to cool the brakes.

P. FIG. 15 shows the cowling of the Internal Combustion Toyota Camry and the Internal Combustion Hybrid Toyota Camry. The magnified illustration of the cowling illustrates the openings have been incorporated with an embodiment of the present invention.

Q. FIG. 16 shows a combination light and turbine device. The light is for identification and illumination and uniquely is self-powering as the vehicle moves forward.

R. FIG. 17 shows a combination high intensity light and turbine device. The light is for identification and illumination and uniquely is self-powering as the vehicle moves forward.

### SIGNIFICANCE OF THE INVENTION

The invention in a battery vehicle and a hybrid electric battery vehicle and would function as a range extender. The scoop can also be a faceplate. The electricity produced can also be utilized in any vehicle including fuel cell vehicles, to produce power for housekeeping requirements of the vehicle. The airflow from the scoop can be utilized and directed through the fuel cell compartment to remove any hydrogen in case of any leak or malfunction.

The air from the scoop could also be directed through the battery compartment of a battery powered or hybrid electric vehicle to remove any hydrogen from these compartments and assist in the cooling of these systems. Therefore the scoop system also functions as a safety device. A sensor could detect any leak of gaseous fuel, trigger an alarm as an example and start the system to exhaust such leak. This invention incorporates that any motor performing this operation could be spark proof or explosion proof if required for safe operation.

By the use of the scoop system, the power requirements of vehicles utilizing electricity can be reduced. This is extremely important and a feature of this invention is that by its utilization the size and cost of fuel cells for fuel cell powered vehicles can be reduced. This is a significant improvement given the extremely high cost of fuel cells and the weight of the fuel cell balance of plant. This invention provides these vehicles with a unique advantage over the same fuel cell vehicles without the present invention. It must be understood this wind generating systems requires only the vehicle to be moving to produce power.

This embodiment of the present invention is a unique assemblage of a battery powered vehicle and a wind or air generator.

This unique assemblage improves the battery vehicle and produces additional electricity without the inclusion of more batteries. Comparing the same old battery powered vehicle to the improved battery powered vehicle, the vehicle of the present invention produces more or additional electricity than the same vehicle without the present invention. This additional electricity production increases the range of the battery powered vehicle, it can increase load carrying capabilities and increase the time between discharges of the battery and can therefore uniquely increase the life of batteries.

In brief, a contest between a battery vehicle unimproved verses the same vehicle improved by the present invention would find the improved vehicle would go that same distance and be able to go farther or even help to recharge the unimproved vehicle. Never the less the improved vehicle is the winner.

An additional embodiment and significant improvement in battery vehicles is afforded by the present invention and is claimed herein as an apparatus and method of improving battery vehicle range during winter or cold weather.

Embodiments of the present invention do not direct the outside air into the vehicle. This is significant for winter and cold weather operations. A turbine that would direct cold outside air inside a battery-powered vehicle would further lower temperatures and degrade the limited operation of the batteries in the cold weather. This embodiment of the present invention directs the electricity from the turbine to heaters to warm the batteries and thereby improve their performance.

This embodiment also benefits the internal combustion hybrid vehicle, the fuel cell internal combustion hybrid vehicle.

The wind generating system will also provide similar advantage to battery powered vehicles by producing electricity helping to reducing electrical demands and therefore reducing the weight and cost of necessary batteries.

This invention and its claims are not limited to gasoline, battery, or fuel cell motorcycles. This invention incorporates and claims hybrid motorcycles as well and is not limited by fuel type, such as gasoline or hydrogen as used in the present invention. Products as claimed by the present invention include but are not limited to fuels, gasoline, hydrogen, batteries, capacitors, battery systems, fuel cells, fuel cell stacks, fuel cell balance of plant as well as supporting and connection systems.

The present invention recognizes and incorporates that this invention is the keystone to return the electric motorcycle to commercial viability, for the development of the hybrid motorcycle and importantly the fuel cell motorcycle. Hybrid motorcycles as envisioned by this invention will desire to have regenerative breaking as do hybrid automobiles. The energy to be stored from such regenerative breaking requires a storage media, such as batteries or even capacitors. The present invention provides a space and housing for the energy storage media.

The present invention is key for the development of the fuel cell motorcycle, and the hybrid fuel cell. The hybrid fuel cell motorcycle will need to store significant electricity, this invention provides, space and housing for such storage. Fuel cell motorcycles by this invention will utilize batteries or capacitors in conjunction with fuel cells. This has the distinct advantage of reducing the power requirements necessary from fuel cells and will thereby reduce their cost and hasten their initial commercial introduction.

### SIGNIFICANCE OF THE INVENTION

The significance of this invention involves providing and teaching the processes, methods and apparatus to enhance and make fuel cell, hybrid fuel cell, internal combustion hybrid vehicles more functionally viable, more workable and commercial system and includes the following:

A. This invention has developed methods and processes to innovatively identify and develop dual uses for components for the vehicular market place.

B. This invention developed devices and methods to improve the fuel cell vehicle by improving the range of a fuel cell vehicle.

C. This invention improves the fuel cell vehicle and is supportive of its early introduction. As an example, this invention allows more batteries to be added to a battery-powered motorcycle without requiring more space for the batteries. The invention's dual use of the frame provides a housing for the batteries that uniquely adds little or no extra weight and requires no additional room for this housing.

D. This invention developed the device that is a vehicular light to simultaneously be a generator.

E. This invention developed the device, the self powering running or signaling light.

F. This invention is applicable to other vehicle types including gasoline, electric, fuel cell, or hybrid powered.

G. This innovation brings commercial viability to battery powered motorcycles by viably adding more batteries thereby directly extending their range.

H. This innovation also decreases the need for batteries in hybrid vehicles. By reducing the need for onboard battery storage, the hybrid vehicle has less battery weight, less battery cost and increases mile per gallon rates.

I. The present invention increases the power available to the vehicle. The present invention also increases the load carrying capacity of fuel cell vehicles, thereby increasing their desirability to the general public.

J. This invention is extended to other vehicle types including motorcycles, motor scooters, motorcycle trikes and motor bikes.

K. This invention accommodates a wide variety of technologies. Fuel cells and hybrid technologies are examples of technologies that will be able to be incorporated and become beneficiaries of this invention.

L. This invention modifies and improves an electric motorcycle and help to bring back to commercialization an improved electric motorcycle. This motorcycle improved by the present invention will be economical, commercially viable and can be purchased by many worldwide as compared to four wheel passenger vehicles.

M. This invention makes possible improvements to expedite the worldwide distribution of an environmentally clean, more affordable vehicle for public transportation.

N. This innovation will help to lower pollution.

O. The present invention will allow the fuel cell, hybrid fuel cell and hybrid electric internal combustion vehicle to have more electric power and be more able to produce electricity for the powering of off board loads.

P. Hybrid vehicles will have improved gasoline mileage and thereby displace more fossil fuels.

Q. This invention increases the electric power of fuel cell and hybrid vehicles and allows for designers to have more freedom to design these vehicles.

R. This invention by its electric nature is focused to reduce the amount of imported oil.

1. Apparatus for producing light from a self generating source of energy, comprising:
a) a light to provide illumination;
b) a self generating source of energy, such as a wind turbine;
c) means to transfer said energy to said light.

2. Apparatus in accordance with claim 1, wherein the light to provide illumination is a high intensity spot or headlight.

3. Apparatus in accordance with claim 1, wherein the light to provide illumination is an incandescent light.

4. Apparatus in accordance with claim 1, wherein the light to provide illumination is a florescent light.

5. Apparatus in accordance with claim 1, further including a cover in front of the light.

6. Apparatus in accordance with claim 5, further including the cover allows some light to pass through it and contains a means to add color to the light cover.

7. Apparatus in accordance with claim 6, further including multiple units.

8. A method of increasing the range of a fuel cell vehicle, comprising the steps of:
a) providing means of additional electric generation on board the fuel cell vehicle,
b) generating electricity on board the fuel cell vehicle,
c) directing said electricity away from any on board storage system,
d) providing a discriminator or control means to direct said electric production to most intense or most costly on board use or load.
e) reducing the electric load demand to the fuel cell by the electricity generated,
f) distributing said electricity to the on board load thereby reducing the fuel cells hydrogen fuel consumption rate and extending range of a fuel cell.

9. A method of increasing the range of a hybrid fuel cell vehicle, comprising the steps of:
a) providing a means of additional electric generation on board the fuel cell vehicle,
b) generating electricity on board the hybrid fuel cell vehicle,
c) directing said electricity away from any on board storage system,
d) providing a discriminator or control means to direct said electric production to most intense or most costly on board use or load,
e) reducing the electric burden of the fuel cell system thereby allowing it to operate in an improved or higher efficiency level.

10. A method of increasing the number of miles per gallon of gas in a hybrid internal combustion vehicle, comprising the steps of:
a) providing means of additional electric generation on board the fuel cell vehicle,
b) generating electricity on board the fuel cell vehicle,
c) directing said electricity away from any on board storage system,
d) providing a discriminator or control means to direct said electric production to most intense or most costly on board use or load.

11. A method in accordance with claim 10, wherein the priority use is the air conditioning system.

12. A method in accordance with claim 11, wherein the added electricity is directed to reduce the internal combustions engines operating load and operating time by providing electricity to the air-conditioning system operating on low thereby reducing engine operating time, and improving the overall gasoline mile per gallon rate.

13. A method in accordance with claim 12, wherein the added electricity is directed to reduce the internal combustions engines operating load and operating time by providing electricity to the air-conditioning system operating on maximum thereby reducing the almost constant internal combustion engine operation and the reduced engine operating time improves the overall gasoline mile per gallon rate.

14. A method of utilizing the electric generation devices in a vehicle without incurring the losses of energy storage or cost of energy storage by always directing the electricity to an operating load of the vehicle.

15. Method in accordance with claim 13, further including adding a switch or other means to turn on or off the apparatus.

16. A method in accordance with claim 13 of providing a selector switch or other means to select the sound to be made.

17. A method in accordance with claim 13, further connecting the playback device to throttle selector or other means to modify the sound volume produced to movement of the throttle selector, rheostat or other means.
